(19) United States
(12) Patent Application Publication
(10) Pub. No.: US 2024/0338941 A1
(43) Pub. Date: Oct. 10, 2024

(54) IMAGE PROCESSING APPARATUS, AND IMAGE PROCESSING METHOD

(71) Applicants: CANON KABUSHIKI KAISHA, Tokyo (JP); CANON MEDICAL SYSTEMS CORPORATION, Tochigi (JP)

(72) Inventor: Itaru OTOMARU, Kanagawa (JP)

(21) Appl. No.: 18/623,081

(22) Filed: Apr. 1, 2024

(30) Foreign Application Priority Data
Apr. 10, 2023 (JP) 2023-063242

(51) Int. Cl. G06V 10/98; G06V 10/46

(52) U.S. Cl. CPC G06V 10/98; G06V 10/46

(57) ABSTRACT

An image processing apparatus includes: a memory storing a program; and one or more processors which, by executing the program, function as: an image acquisition unit configured to acquire an object image obtained by capturing an image of an object; an invalid-region acquisition unit configured to acquire information related to an invalid region, which is a region that is outside an image capturing range or where the object is not present, in the object image; an acquisition unit configured to acquire a result of estimating a predetermined region based on the object image; and a determination unit configured to determine, by using the information related to the invalid region, whether or not the estimation of the predetermined region is successful.

### BACKGROUND OF THE INVENTION

### Field of the Invention

The present invention relates to an image processing apparatus and an image processing method.

### Description of the Related Art

In diagnosis using a medical image, a shape of a predetermined object in the image is extracted by region extraction (segmentation) or contour extraction, and various functional analysis based on the extracted shape is performed. Manual extraction of the object shape is a task that requires skill and places a burden on an operator (such as a doctor), and therefore automated extraction of the object shape is one of major focuses of attention in medical image processing.

Thus far, various technologies based on deep learning have been proposed, a representative example of which is U-Net shown in Olaf Ronneberger et al., U-Net: Convolutional Networks for Biomedical Image Segmentation, Medical Image Computing and Computer-Assisted Intervention-MICCAI 2015, Lecture Notes in Computer Science, vol. 9351, pp. 234-241.

The challenge in automated extraction (estimation) of an object shape is how to reduce a risk of failed estimation. In diagnosis, an image having features not included in learning data, such as an image with image capturing settings different from those in the learning data or an image with an image quality lower than that in the learning data may be input. When an image having features not included in the learning data is input, an error may occur in a result of the extraction of the object shape.

To solve the challenge, a technology that aims at improving performance by padding out learning data and generating a large number of variations from the limited learning data has been known. Meanwhile, Japanese Patent Application Publication No. 2013-51217 discloses a technology that senses failures in image capturing and image processing and performs recovery processing by switching to another method or the like.

However, according to these methods described in prior art, a region (invalid region) where no object is present, such as an extracorporeal region, may be estimated as an object region.

### SUMMARY OF THE INVENTION

The present disclosure has been made in view of the foregoing, and provides a technology that improves estimation accuracy in processing of estimating a predetermined region in an image.

An image processing apparatus according to the present disclosure includes: a memory storing a program; and one or more processors which, by executing the program, function as: an image acquisition unit configured to acquire an object image obtained by capturing an image of an object; an invalid-region acquisition unit configured to acquire information related to an invalid region, which is a region that is outside an image capturing range or where the object is not present, in the object image; an acquisition unit configured to acquire a result of estimating a predetermined region based on the object image; and a determination unit configured to determine, by using the information related to the invalid region, whether or not the estimation of the predetermined region is successful.

An image processing method according to the present disclosure includes: acquiring an object image obtained by capturing an image of an object; acquiring information related to an invalid region, which is a region that is outside an image capturing range or where the object is not present, in the object image; acquiring a result of estimating a predetermined region based on the object image; and determining, by using the information related to the invalid region, whether or not an estimation of the predetermined region is successful.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of an image processing system according to a first embodiment;

FIG. 2 is a flow chart illustrating an example of processing in an image processing apparatus in the first embodiment;

FIG. 3A is a diagram schematically illustrating a reference cross section;

FIG. 3B is a diagram schematically illustrating an endocardial contour on the reference cross section;

FIGS. 4A and 4B are diagrams illustrating an invalid region;

FIGS. 5A and 5B are diagrams illustrating determination of whether or not estimation of the endocardial contour using the invalid region is successful;

FIGS. 6A and 6B are diagrams illustrating another example of the invalid region;

FIG. 7 is a diagram illustrating an example of a configuration of an image processing system according to a second embodiment;

FIG. 8 is a flow chart illustrating an example of processing in an image processing apparatus in the second embodiment;

FIG. 9 is a diagram illustrating an example of a configuration of an image processing system according to a third embodiment; and

FIG. 10 is a flow chart illustrating an example of processing in an image processing apparatus in the third embodiment.

### DESCRIPTION OF THE EMBODIMENTS

Referring to the drawings, a description will be given below of embodiments of the present invention. Note that the present disclosure is not limited to the following embodiments, and can be changed as appropriate within a scope not departing from the gist thereof. In addition, in the drawings described below, configurations having the same functions are denoted by the same reference signs, and a description thereof may be omitted or simplified.

An image processing apparatus according to each of the embodiments described below offers a function of estimating a predetermined reference cross section for a doctor or the like to observe or diagnose an input three-dimensional image as well as a contour of a predetermined region (object) seen on the reference cross section. An input image serving as a processing target is a medical image, i.e., an image of an object (such as a human body) photographed or generated for the purpose of medical diagnosis, examination, study, or the like, which is typically an image acquired by an image capturing system referred to as a modality. As an example of the input image, an ultrasonic image obtained by an ultrasonic diagnostic apparatus can be listed. Alternatively, the input image may also be an X-ray CT image obtained by an X-ray CT (Computed Tomographic) apparatus, an MRI image obtained by an MRI (Magnetic Resonance Imaging) apparatus, or the like.

In the following description, the image processing apparatus acquires, as the input three-dimensional image, a trans-sternal three-dimensional ultrasonic image obtained by capturing an image of a right ventricular region of a heart. The image processing apparatus estimates a reference cross section of the right ventricular region, which is an observation target, and estimates an endocardial contour as the predetermined region.

### First Embodiment

An image processing apparatus according to the first embodiment uses a three-dimensional image as the input image to estimate parameters (hereinafter referred to as reference cross-section parameters) representing a position and an orientation of a reference cross section for observing a right ventricle and estimate coordinates of individual points in a point group representing an endocardial contour of the right ventricle in the reference cross section. At that time, the image processing apparatus acquires, as an invalid region, a region in the reference cross section where the endocardial contour should not be located. The image processing apparatus determines whether or not processing of estimating the endocardial contour is successful depending on whether or not the estimated endocardial contour points are present in the invalid region. When determining that the estimation processing has failed, the image processing apparatus switches a contour estimation algorithm to another algorithm and performs the estimation processing again. In a case where a failed state does not disappear even when any algorithm is used, the image processing apparatus outputs that the processing has failed.

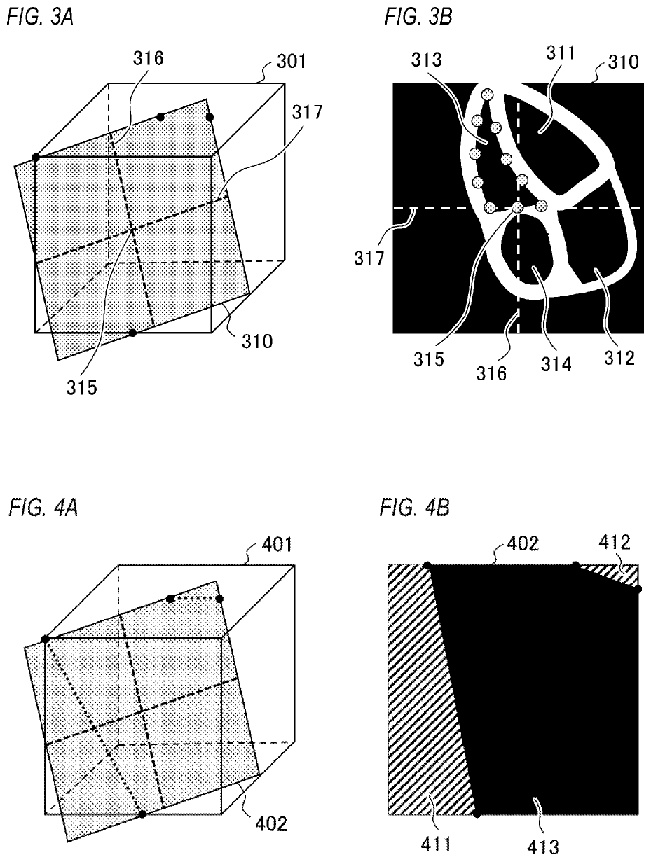

FIGS. 3A and 3B are diagrams schematically illustrating the reference cross section and the right ventricular endocardial contour on the reference cross section. As illustrated inn FIG. 3A, a reference cross-sectional image 310 is a two-dimensional cross-sectional image obtained by cutting an input three-dimensional image 301 at a predetermined position and in a predetermined orientation. In an example in FIG. 3B, the reference cross-sectional image 310 is a cross-sectional image that is cut so as to allow four chambers of a left ventricle 311, a left atrium 312, a right ventricle 313, and a right atrium 314 to be observed and uses a center of a right ventricular valve annulus as a center position 315. A horizontal axis 317 of the reference cross-sectional image 310 is an axis connecting left and right valve annuli, while a vertical axis 316 thereof is an axis perpendicular to the horizontal axis 317. The reference cross-sectional image 310 can be represented by nine parameters of a center position (cx, cy, cz), a vertical axis vector (lx, ly, lz), and a horizontal axis vector (sx, sy, sz) with respect to the three-dimensional image. The endocardial contour point group refers to a point group representing the endocardial contour of the right ventricle on the reference cross-sectional image 310, which is a discrete point group surrounding the right ventricle 313.

In defining the reference cross-sectional image 310, it is to be noted that an image size (the number of pixels) of the reference cross-sectional image is invariable (e.g., 256×256 pixels) irrespective of a case and that scaling is not performed. Accordingly, depending on a position of a center point of the right ventricular valve annulus, the reference cross-sectional image 310 including 256×256 pixels may include a region outside an image definition range of the input three-dimensional image 301. The region outside the image definition range of the input three-dimensional image 301 is a region lying outside an image capturing range in the input three-dimensional image 301, and is defined as the invalid region. The invalid region is a three-dimensional region. An image range of the reference cross-sectional image 310 may include the invalid region.

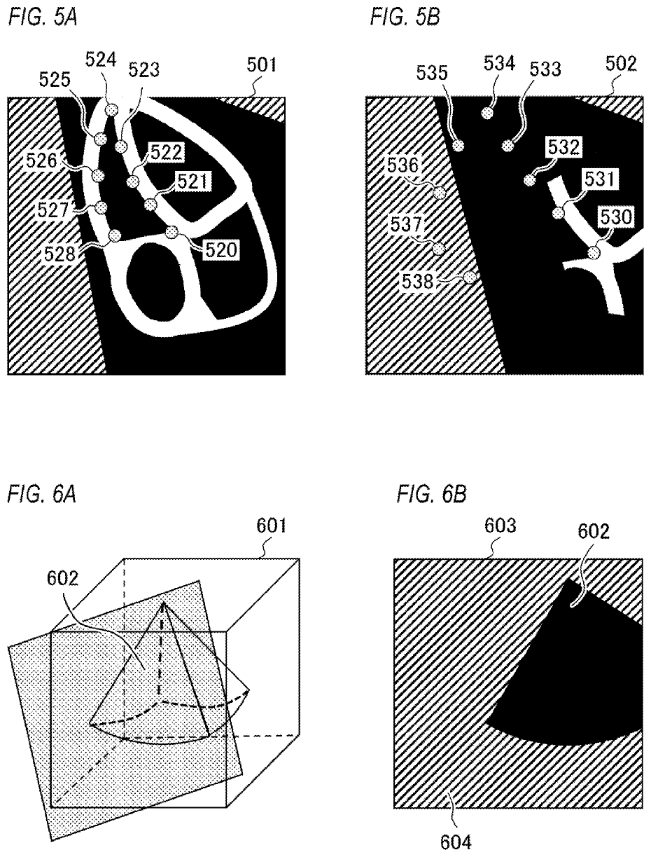

FIGS. 4A and 4B are diagrams illustrating the invalid region. FIG. 4A illustrates a positional relationship of a reference cross-sectional image 402 with respect to an input three-dimensional image 401. A partial region of the reference cross-sectional image 402 is within the image capturing range of the input three-dimensional image, and the other region thereof is outside the image capturing range of the input three-dimensional image. FIG. 4B illustrates, in the reference cross-sectional image 402, respective regions within and outside the image capturing range of the input three-dimensional image. Each of regions 411 and 412 corresponding to a hatched portion is a region outside the image definition range in the input three-dimensional image 401, i.e., the invalid region. A region other than the invalid region, i.e., a solid black region 413 is a valid region.

FIGS. 5A and 5B are diagrams illustrating determination of whether or not the estimation of the endocardial contour using the invalid region is successful. FIG. 5A illustrates an example of a case where the endocardial contour estimation is determined to be successful. In a reference cross-sectional image 501, a right ventricular region is depicted with excellent visibility, and each of points in a group of endocardial contour points 520 to 528 is included in the valid region. Meanwhile, FIG. 5B illustrates an example of a case where the endocardial contour estimation is determined to be a failure. An image quality of a reference cross-sectional image 502 is low, and it is difficult to visually recognize the right ventricular region except in a small region bordering the right atrium and the left ventricle. In the example in FIG. 5B, in a group of estimated endocardial contour points 530 to 538, the points 536 to 538 are included in the invalid region. The image processing apparatus can determine that the endocardial contour estimation has failed when, e.g., at least one of the estimated endocardial contour points is not included in the valid region, and is present in the invalid region.

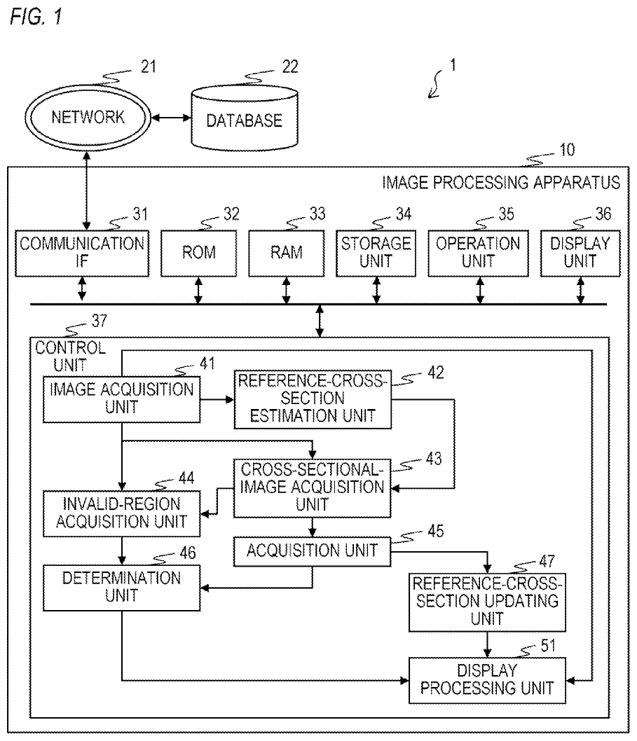

Referring to FIG. 1, a description will be given of a configuration of and processing in the image processing apparatus according to the first embodiment. FIG. 1 is a diagram illustrating an example of a configuration of an image processing system (referred to also as a medical image processing system) 1 according to the first embodiment. The image processing system 1 includes an image processing apparatus 10 and a database 22. The image processing apparatus 10 is communicatively connected to the database 22 via a network 21. The network 21 includes, e.g., a LAN (Local Area Network) or a WAN (Wide Area Network).

The database 22 holds and manages a plurality of images and information to be used in processing in the image processing apparatus 10. The information managed by the database 22 include, e.g., information on the input three-dimensional image to be subjected to reference-cross-section-parameter estimation processing in the image processing apparatus 10. The image processing apparatus 10 can acquire data held in the database 22 via the network 21. When the reference-cross-section-parameter estimation processing and the endocardial-contour estimation processing in the image processing apparatus 10 is to be performed on the basis of a learning model based on machine learning, the database 22 holds and manages information on the learning model. Note that the information on the learning model may also be stored in an internal storage (a ROM 32 or a storage unit 34) of the image processing apparatus 10, not in the database 22.

The image processing apparatus 10 includes a communication IF (Interface) 31, the ROM (Read Only Memory) 32, a RAM (Random Access Memory) 33, the storage unit 34, an operation unit 35, a display unit 36, and a control unit 37.

The communication IF 31 is a communication unit that implements communication between an external device (such as, e.g., the database 22) and the image processing apparatus 10, such as, e.g., a LAN card. The ROM 32 is a nonvolatile memory, and stores various programs and various data. The RAM 33 is a volatile memory, and is used as a work memory that temporarily stores a program being executed and data. The storage unit 34 is, e.g., a HDD (Hard Disk Drive), and stores various programs and various data. The operation unit 35 includes a keyboard, a mouse, a touch panel, and the like, and inputs an instruction from a user (such as, e.g., a doctor or a laboratory technician) to various apparatuses. The display unit 36 includes a display or the like, and displays various information to the user.

The control unit 37 includes a CPU (Central Processing Unit) or the like to perform overall control of processing in the image processing apparatus 10. The control unit 37 includes, as functional configurations, an image acquisition unit 41, a reference-cross-section estimation unit 42, a cross-sectional-image acquisition unit 43, an invalid-region acquisition unit 44, an acquisition unit 45, a determination unit 46, a reference-cross-section updating unit 47, and a display processing unit 51. The control unit 37 may also include a GPU (Graphics Processing Unit), a DSP (Digital Signal Processor), a FPGA (Field-Programmable Gate Array), or the like.

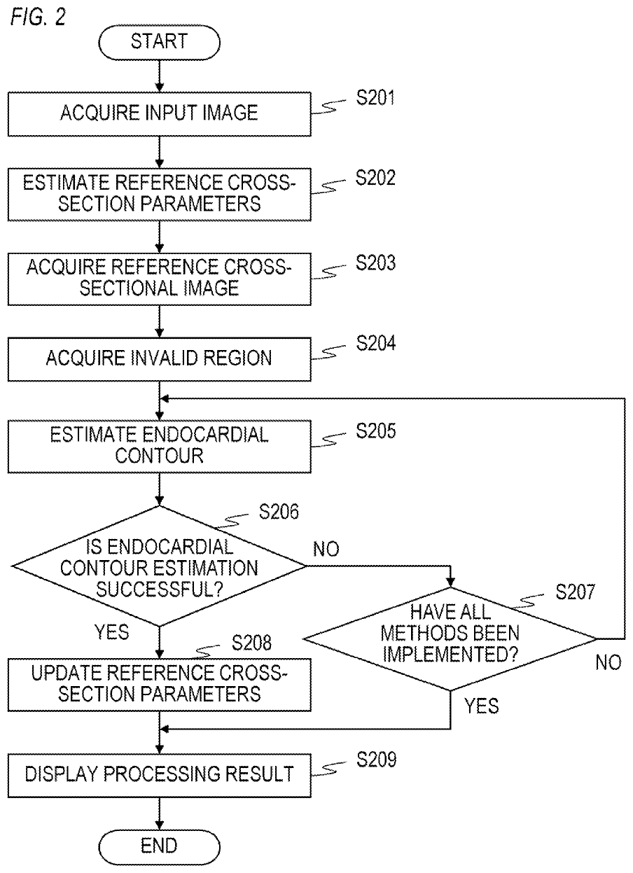

The image acquisition unit 41 acquires, from the database 22, the input three-dimensional image which is a three-dimensional image of an object input to the image processing apparatus 10. Details of processing of acquiring the input three-dimensional image will specifically be described in a description of Step S201 in FIG. 2. The input three-dimensional image may also be acquired directly from a modality (an image capturing system that photographs the object). In this case, the image processing apparatus 10 may also be mounted in a console of the modality.

The reference-cross-section estimation unit 42 estimates, from the input three-dimensional image acquired by the image acquisition unit 41, parameters (reference cross-section parameters) for obtaining the reference cross section. Details of processing of estimating the reference cross-section parameters will specifically be described in a description of Step S202 in FIG. 2.

The cross-sectional-image acquisition unit 43 uses the input three-dimensional image acquired by the image acquisition unit 41 and the reference cross-section parameters estimated by the reference-cross-section estimation unit 42 to acquire, from the input three-dimensional image, a two-dimensional reference cross-sectional image representing the reference cross section. Details of processing of acquiring the two-dimensional reference cross-sectional image will specifically be described in a description of Step S203 in FIG. 2.

The invalid-region acquisition unit 44 uses the input three-dimensional image acquired by the image acquisition unit 41 and the two-dimensional reference cross-sectional image acquired by the cross-sectional-image acquisition unit 43 to acquire the invalid region in the two-dimensional reference cross-sectional image where the right ventricular endocardial contour should not be located. Details of processing of acquiring the invalid region will specifically be described in a description of Step S204 in FIG. 2.

The acquisition unit 45 uses the two-dimensional reference cross-sectional image acquired by the cross-sectional-image acquisition unit 43 to estimate, as the predetermined region, the endocardial contour of the right ventricle. It is assumed that the acquisition unit 45 has two or more contour estimation algorithms. The acquisition unit 45 performs estimation using a first algorithm and, when “failed estimation” is determined by the determination unit 46, the acquisition unit 45 estimates the endocardial contour by using a second algorithm different from the first algorithm. Details of the processing of estimating the endocardial contour will specifically be described in a description of Step S205 in FIG. 2. Note that, in the following example, a description will be given of a mode in which the acquisition unit 45 estimates the endocardial contour (predetermined region), but the acquisition unit 45 may also acquire a result of estimation of the endocardial contour performed by the external device.

The determination unit 46 uses information on the invalid region acquired by the invalid-region acquisition unit 44 and information on the endocardial contour estimated by the acquisition unit 45 to determine whether the estimation of the endocardial contour is successful or a failure. When determining that the endocardial contour estimation has failed, the determination unit 46 determines whether or not there is an algorithm that has not been used for the endocardial contour estimation among the algorithms provided in the acquisition unit 45. Details of processing of determining whether or not the endocardial contour estimation is successful will specifically be described in a description of Steps S206 and S207 in FIG. 2.

The reference-cross-section updating unit 47 updates the reference cross-section parameters representing the position and orientation of the reference cross section on the basis of the information on the endocardial contour estimated by the acquisition unit 45. Details of processing of updating the reference cross-section parameters will specifically be described in Step S208 in FIG. 2.

The display processing unit 51 displays, on an image display region of the display unit 36, information (processing results) processed by the image processing apparatus 10, such as the input three-dimensional image, the reference cross-section parameters, the reference cross-sectional image, and the result of the endocardial contour estimation, in a display mode easily visually recognizable by the user. Details of processing of displaying the processing results will specifically be described in a description of Step S209 in FIG. 2.

Each of the components of the image processing apparatus 10 functions according to a computer program. The function of each of the components is implemented by, e.g., the control unit 37 (CPU) by reading the computer program stored in the ROM 32, the storage unit 34, or the like by using the RAM 33 as a work region and executing the computer program. Note that the functions of any or all of the functions of the components of the image processing apparatus 10 may also be implemented by using dedicated circuits. Meanwhile, the function of any of the components of the control unit 37 may also be implemented by using a cloud computing technology. In this case, the image processing apparatus 10 is communicatively connected to an arithmetic apparatus at a location different from that of the image processing apparatus 10 via the network 21. Then, the image processing apparatus 10 performs transmission/reception of data to/from the arithmetic apparatus to implement the functions of the components of the image processing apparatus 10 and the control unit 37.

FIG. 2 is a flow chart illustrating an example of the processing in the image processing apparatus 10 according to the first embodiment.

(Step S201: Acquisition of Input Image) In Step S201, the image processing apparatus 10 acquires an instruction to acquire an image from the user via the operation unit 35. The image acquisition unit 41 acquires, from the database 22, the input three-dimensional image specified by the user, and stores the input three-dimensional image in the RAM 33. The input three-dimensional image is a captured image resulting from capturing of an image of a heart, a part of the heart, or the like serving as the object. Note that the image acquisition unit 41 is not limited to a case where the input three-dimensional image is acquired from the database 22, and may also acquire an input image from among ultrasonic images captured from time to time by the ultrasonic diagnostic apparatus serving as the image processing apparatus 10. Alternatively, the image acquisition unit 41 may also acquire an ultrasonic image as the input image from the ultrasonic diagnostic apparatus serving as the external device communicative with the image processing apparatus 10.

(Step S202: Estimation of Reference Cross-Section Parameters) In Step S202, the reference-cross-section estimation unit 42 uses volume data of the input three-dimensional image as an input to estimate the reference cross-section parameters defining a center position and the orientation of the reference cross section. Examples of the reference cross-section parameters include, e.g., a set of the center position, the vertical axis vector, the horizontal axis vector (each including 3 parameters, resulting in a total of 9 parameters).

For example, the reference-cross-section estimation unit 42 can estimate the reference cross-section parameters by using a method based on a convolutional neural network (CNN). In other words, the reference-cross-section estimation unit 42 estimates the reference cross-section parameters by using a learning model preliminarily trained to learn a relationship of the reference cross-section parameters with respect to a three-dimensional ultrasonic image obtained by capturing an image of the right ventricular region by using the CNN. In the processing in Step S202, the reference-cross-section estimation unit 42 estimates the reference cross-section parameters from the input three-dimensional image by using the learning model trained on the basis of the CNN.

Specifically, the reference-cross-section estimation unit 42 acquires, from the database 22, the learning model trained to learn the relationship of the reference cross-section parameters with respect to the input three-dimensional image and stores the learning model in the RAM 33. The reference-cross-section estimation unit 42 can acquire the reference cross-section parameters by inputting the input three-dimensional image stored in the RAM 33 in Step S201 to the learning model. The reference-cross-section estimation unit 42 stores the acquired reference cross-section parameters in the RAM 33.

The three-dimensional image input to the learning model using the CNN need not be the same as the input three-dimensional image acquired in Step S201, but may also be a “rough” image obtained by reducing a resolution of the input three-dimensional image. For example, it is assumed that the input three-dimensional image is a volume image in which a length per voxel is 0.6 mm and which represents a range of 256×256×256 voxels, i.e., 153.6 mm on each side. In Step S202, the reference-cross-section estimation unit 42 reduces the number of the voxels on each side of the input three-dimensional image to ¼, i.e., 64×64×64 voxels. In other words, the image is transformed to an image in which the represented range remains unchanged at 153.6 mm on each side, while a length per voxel is 2.4 mm.

By reducing the resolution of the input three-dimensional image, the reference-cross-section estimation unit 42 can reduce calculation time for the estimation using the CNN and an amount of memory usage compared to a case where the input three-dimensional image is used as is. In addition, the reference-cross-section estimation unit 42 may also apply, as preparatory processing, known image processing such as pixel value normalization using the mean and variance of pixel values or contrast correction to the input three-dimensional image input to the learning model.

The reference-cross-section estimation unit 42 can perform resolution conversion processing by using a known optional method. For example, the reference-cross-section estimation unit 42 can sample a voxel value in a step according to a reduction width or use an average value of pixel values of voxels in a range according to the reduction width. In addition, the image processing such as the resolution conversion processing and the pixel value normalization can be performed in any order. The reference-cross-section estimation unit 42 may also estimate the reference cross-section parameters without performing the resolution conversion processing and the image processing each described above.

An output of the estimation by the learning model using the CNN is, e.g., 9 parameters representing the reference cross section, but may be in any representation format as long as the position and orientation of the reference cross section can be represented (i.e., rigid transformation can be represented) thereby. The output of the estimation using the CNN is not limited to the 9 parameters, and may also be, e.g., 7 parameters (center-position 3 parameters, rotation-axis-vector 3 parameters, and rotation-angle 1 parameter) representing the reference cross section. The reference-cross-section estimation unit 42 may also convert the 7 parameters output as a result of the estimation based on the CNN to a representation format using the 9 parameters for the center position, the vertical axis vector, and the horizontal axis vector (3 parameters for each).

Alternatively, the output of the estimation using the CNN may also be a 4×4 rigid transformation matrix. The learning model using the CNN may also have a configuration which estimates the orientation by fixing the position or a configuration which estimates the position by fixing the orientation. Alternatively, the learning model using the CNN may also have a configuration which estimates parameters including those for scale transformation in addition to those for the position and the orientation or a configuration which estimates affine transformation parameters. Thus, the learning model using the CNN needs only to be a learning model that uses the input three-dimensional image as an input and outputs the parameters specifying the position and orientation of the two-dimensional reference cross-sectional image in the input three-dimensional image.

Alternatively, the learning model for estimating the reference cross-section parameters is not limited to the learning model built in advance and stored in the database 22, and may also be a learning model built by the control unit 37 of the image processing apparatus 10. The control unit 37 includes a training unit not shown, and the training unit may also build the learning model by using the input three-dimensional image and the reference cross-section parameters each input as training data. The training unit may also train the learning model by using, as the training data, the input three-dimensional image acquired in Step S201 and the reference cross-section parameters updated in Step S208. By training the learning model by using the updated reference cross-section parameters, the training unit can continuously improve accuracy of the estimation of the reference cross-section parameters by the learning model.

Note that, as long as the reference cross-section parameters can be acquired, the reference-cross-section estimation unit 42 may also acquire the reference cross-section parameters by any method other than a method of performing the estimation by using the learning model using the CNN. For example, the reference-cross-section estimation unit 42 may also acquire the reference cross-section parameters manually set by the user via the operation unit 35 or may also acquire the reference cross-section parameters by reading the reference cross-section parameters held in advance in the database 22.

(Step S203: Acquisition of Reference Cross-Sectional Image) In Step S203, the cross-sectional-image acquisition unit 43 uses the input three-dimensional image acquired in Step S201 and the reference cross-section parameters estimated in Step S202 to acquire the two-dimensional reference cross-sectional image (two-dimensional cross-sectional image). The cross-sectional-image acquisition unit 43 cuts a region (cross section) in which the right ventricle or the like as the object is depicted out of the input three-dimensional image to acquire the two-dimensional reference cross-sectional image. The two-dimensional reference cross-sectional image in the first embodiment corresponds to the object image. The cross-sectional-image acquisition unit 43 cuts the reference cross-sectional image out of the input three-dimensional image such that a center position of the reference cross-section parameters serves as a center of the reference cross-sectional image. For example, by using a valve annulus center of the right ventricle as the center position of the reference cross section, the cross-sectional-image acquisition unit 43 can cut out the two-dimensional reference cross-sectional image including the right ventricle corresponding to a part of the object in the input three-dimensional image.

Referring to FIG. 3A, processing of acquiring the reference cross-sectional image 310 will specifically be described. The cross-sectional image acquisition unit 43 can acquire the two-dimensional reference cross-sectional image 310 by sampling the input three-dimensional image 301 on the basis of the center position 315, the vertical axis 316, and the horizontal axis 317 of the right ventricular valve annulus. On the assumption that a length per pixel is the same as that in the input three-dimensional image (e.g., 0.6 mm), the cross-sectional-image acquisition unit 43 samples a range of 256×256 pixels (153.6 mm×153.6 mm when a length per pixel is 0.6 mm). The cross-sectional-image acquisition unit 43 stores the acquired two-dimensional reference cross-sectional image in the RAM 33. Note that the pixel size of the two-dimensional cross-sectional image need not be the same as the voxel size in the input three-dimensional image.

(Step S204: Acquisition of Invalid Region) In Step S204, the invalid-region acquisition unit 44 uses the input three-dimensional image acquired in Step S201 and the two-dimensional reference cross-sectional image acquired in Step S203 to acquire information related to the invalid region. The invalid region is the three-dimensional region where the right ventricular endocardial contour serving as the estimation target should not be located, and is specifically a region outside the image definition range of the input three-dimensional image (outside the image capturing range). The invalid-region acquisition unit 44 specifies a region corresponding to the invalid region in the two-dimensional reference cross-sectional image.

A specific description will be given of a method of acquiring the invalid region. The invalid-region acquisition unit 44 performs coordinate transformation on each of pixels in the two-dimensional reference cross-sectional image including 256×256 pixels, and calculates a voxel position of each of the pixels in the input three-dimensional image. When the calculated voxel position in the three-dimensional image indicates the outside of the image definition range of the input three-dimensional image, the pixel is defined as an “invalid pixel”.

When the input three-dimensional image is, e.g., an image including 256×256×256 voxels, the voxel position indicating “the outside of the image definition range of the input three-dimensional image” is specifically a voxel position at which there is at least one value smaller than 0 or at least one value larger than 255 in each of components. The invalid-region acquisition unit 44 prepares an image region having the same size (256×256 pixels) as that of the two-dimensional reference cross-sectional image, and stores a value that identifies invalidity at a position of the invalid pixel. The invalid-region acquisition unit 44 can acquire (define) the invalid region by determining whether or not each of the pixels in the two-dimensional reference cross-sectional image is the invalid pixel.

FIG. 4B illustrates an example in which each of the regions 411 and 412 corresponding to the hatched portion outside the image definition range of the input three-dimensional image is set as the invalid region, but the invalid region may also be set in the input three-dimensional image. FIGS. 6A and 6B are diagrams illustrating another example of the invalid region. FIG. 6A illustrates a region 602 which is an image reconstruction region (i.e., photographing possible region) in the three-dimensional ultrasonic image. The region 602 is a partial region of an input three-dimensional image 601. A shape of the photographing possible region using an ultrasonic probe is not limited to a rectangular parallelpiped shape. In this case, the invalid-region acquisition unit 44 determines the region 602 which is the image reconstruction region to be the valid region, while determining the outside of the region 602 to be the invalid region.

FIG. 6B illustrates the valid region 602 and an invalid region 604 each acquired in a two-dimensional reference cross-sectional image 603. Instead of causing the valid region 602 to match the image reconstruction region, it may also be possible to extend the valid region 602 by about several pixels beyond the image reconstruction region to provide the valid region 602 with a margin. By providing the valid region 602 with the margin, when a real right ventricular region is photographed with a part thereof being unseen outside the image reconstruction region, it is possible to reduce a possibility that the failed estimation is determined despite correct estimation of the endocardial contour.

(Step S205: Estimation of Endocardial Contour) In Step S205, the acquisition unit 45 estimates the endocardial contour by using the reference cross-sectional image acquired in Step S203. The endocardial contour is an example of a predetermined region, and is formed of, e.g., a plurality of contour points. Specifically, the acquisition unit 45 estimates two-dimensional coordinates (X, Y) of each of points in the point group representing the right ventricular endocardial contour. The right ventricular endocardial contour is represented by a predetermined number of points determined in advance. When the right ventricular endocardial contour is represented by, e.g., a group of seventeen points, the acquisition unit 45 estimates 34 numerical value data items as the X-coordinates and the Y-coordinates of the individual points.

The acquisition unit 45 has at least two algorithms (estimation methods) for estimating the predetermined region. In the description of FIG. 2, the algorithms for estimating the predetermined region are assumed to be two known methods which are a method using the CNN and a method using principal component analysis (PCA) described in Toshiyuki Amano et al., An appearance based fast linear pose estimation, MVA 2009 IAPR Conference on Machine Vision Applications. Either of the methods is a method based on learning data, and the learning model that estimates the predetermined region such as a group of endocardial contour points is built by causing relationships between the two-dimensional reference cross-sectional image and the coordinates of the individual points in the endocardial control point group in the reference cross-sectional image to be learned. In other words, the acquisition unit 45 estimates the predetermined region in the object image input to the learning model by using the learning model trained to learn the relationships between the two-dimensional reference cross-sectional image (object image) and the corresponding predetermined region.

As specific processing in Step S205, the acquisition unit 45 selects the algorithms to be used to estimate the endocardial contour. When Step S205 is reached and the estimation of the endocardial contour is performed in none of the algorithms, the acquisition unit 45 selects the algorithm using the CNN, and acquires the learning model corresponding to the CNN from the database 22.

Meanwhile, when it is determined by the determination unit 46 that “the algorithm using the CNN has been executed and failed” in processing in Step S206 described later, the acquisition unit 45 selects the algorithm using the PCA and acquires the learning model corresponding to the PCA.

The acquisition unit 45 estimates the coordinates of the individual points in the endocardial contour point group by using the reference cross-sectional image acquired in Step S203 and the read learning model. The acquisition unit 45 stores, in the RAM, the coordinates of the individual points in the endocardial contour point group obtained through the estimation.

(Step S206: Determination of Success or Failure of Endocardial Contour Estimation) In Step S206, the determination unit 46 determines whether or not the endocardial contour estimation is successful. When each of the points in the endocardial contour point group estimated in Step S205 is present within the valid region, the determination unit 46 determines that the estimation of the endocardial contour is successful. In other words, the determination unit 46 determines that the estimation of the endocardial contour has failed when at least one of the group of endocardial contour points (a plurality of contour points) is present in the invalid region acquired in Step S204. Note that the determination unit 46 may also determine that the endocardial contour estimation has failed when not just one point, but more than a predetermined number of endocardial contour points (e.g., three or more contour points) are present in the invalid region.

Referring to FIGS. 5A and 5B, a procedure of determining whether or not the endocardial contour estimation is successful will specifically be described. The determination unit 46 reads, from the RAM 33, a two-dimensional image representing the invalid region acquired in Step S204. The determination unit 46 determines whether or not each of the points in the endocardial contour point group is present within a range of the invalid region. FIG. 5A illustrates an example when each of the group of the endocardial contour points 520 to 528 is located within the valid region, and “successful estimation” is determined. Meanwhile, FIG. 5B illustrates an example when some points, which are the points 536 to 538, are located in the invalid region, and “failed estimation” is determined. When it is determined that the endocardial contour estimation is successful (YES in Step S206), the processing advances to Step S208. When it is determined that the endocardial contour estimation has failed (NO in Step S206), the processing advances to Step S207.

(Step S207: Determination of Whether or Not All Estimation Methods Have Been Implemented) In Step S207, the determination unit 46 determines whether or not all the endocardial contour estimation methods (algorithms) in the acquisition unit 45 have been implemented. When it is determined that all the algorithms have been executed (YES in Step S207), the estimation of the endocardial contour using any of the methods has failed, and the processing advances of Step S209. In Step S209, the user is notified that the estimation of the endocardial contour has failed. Meanwhile, when there is the algorithm that has not been executed yet (NO in Step S207), the processing returns to Step S205. In Step S205, the acquisition unit 45 performs the endocardial contour estimation again by using the algorithm that has not been executed yet.

(Step S208: Updating of Reference Cross-Section Parameters) In Step S208, the reference-cross-section updating unit 47 updates the reference cross-section parameters on the basis of a result of estimation of the right ventricular endocardial contour performed in Step S205 and determined to be successful in Step S206. Processing in Step S208 is processing to be performed to maintain consistency between the reference cross-section parameters and the right ventricular endocardial contour.

Referring FIG. 3B, a description will be given of a reason for performing the processing of updating the reference cross-section parameters. The reference cross section is a cross section in which the four chambers are visually recognizable, and is defined as a cross section using the center of the right ventricular valve annulus as the center position 315 and using a vector connecting the left and right valve annuli as the horizontal axis 317. In Step S202, the coordinates of each of the points in the endocardial contour point group are not estimated, but the reference-cross-section estimation unit 42 estimates the reference cross-section parameters by using the learning data of the reference cross-section parameters with respect to the reference cross section defined as described above. Meanwhile, in Step S205, the acquisition unit 45 estimates the endocardial contour on the basis of the two-dimensional reference cross-sectional image without considering the center position 315 of the reference cross-section parameters, the vertical axis 316, and the horizontal axis 317. Accordingly, the vector connecting the left and right valve annuli may not match the horizontal axis 317 of the reference cross-sectional image, and a middle between the left and right valve annuli may not match the center position 315 of the reference cross-sectional image. As a result, when the updating processing is not performed, the reference cross-section parameters may not be consistent with the definition of the reference cross section.

To eliminate the inconsistency with the definition of the reference cross section, in Step S208, the reference-cross-section updating unit 47 performs parallel movement and rotation of the reference cross-section parameters on the basis of the right ventricular endocardial contour the estimation of which is determined to be successful in Step S206. First, the reference-cross-section updating unit 47 uses the cross-section parameters estimated in Step S202 to perform coordinate transformation of the coordinate value of each of the points in the endocardial contour point group represented by the two-dimensional coordinates to a three-dimensional coordinate value in a space of the input three-dimensional image.

Next, the reference-cross-section updating unit 47 updates the reference cross-section parameters. In other words, the reference-cross-section updating unit 47 causes in-plane parallel movement of a center position (cx, cy, cz) of the reference cross-section parameters such that the center position matches the middle between the left and right valve annuli of the right ventricular endocardial contour. In addition, the reference-cross-section updating unit 47 causes in-plane rotation of a horizontal axis vector (sx, sy, sz) of the reference cross-section parameters such that the horizontal axis vector matches the vector connecting the left and right valve annuli. The reference-cross-section updating unit 47 stores, in the RAM 33, the updated reference cross-section parameters as new reference cross-section parameters.

By the processing of updating the reference cross-section parameters performed in Step S208, the consistency between the reference cross-section parameters and the right ventricular endocardial contour is maintained. Note that the reference-cross-section updating unit 47 need not perform the processing in Step S208.

(Step S209: Display of Processing Result) In Step S209, the display processing unit 51 displays, on the image display region of the display unit 36, information on the processing result in the image processing apparatus 10 illustrated in FIG. 2 in a display mode easily visually recognizable by the user. The information on the processing result displayed on the display unit 36 in Step S209 includes, e.g., the two-dimensional reference cross-sectional image based on the reference cross-section parameters estimated in Step S202 and updated in Step S208. In addition, the information on the processing result includes the right ventricular endocardial contour (predetermined region) estimated in Step S205 and a result of determining whether or not the estimation of the right ventricular endocardial contour in Step S206 is successful. When the result of the determination in Step S207 is “YES” and the estimation of the endocardial contour is unsuccessful even when any of the algorithms is applied, the display processing unit 51 displays information notifying the user of the failed estimation, instead of information on the right ventricular endocardial contour.

Note that, when it is intended to perform analysis or measurement based on the reference cross section and the object shape such as the estimated right ventricular endocardial contour, the display processing unit 51 need not perform the display processing in Step S209. In this case, the information on the right ventricular endocardial contour, the result of determining whether or not the estimation is successful, and the reference cross-section parameters obtained in Steps S205, S206, and S208 may also be stored in the RAM 33, the storage unit 34, or the like or may also be output to the external device instead of being displayed on the display unit 36. Alternatively, the control unit 37 of the image processing apparatus 10 may also include an analysis unit that performs analysis and measurement each using the reference cross section and the object shape and is not shown, and the reference cross-section parameters, the right ventricular endocardial contour, and the result of determining whether or not the estimation is successful may also be transmitted to the analysis unit.

According to the first embodiment described above, the image processing apparatus 10 estimates the predetermined region, such as the contour of the object, on the reference cross-sectional image cut out of the three-dimensional image, and determines whether or not the estimation is successful by using the invalid region on the reference cross-sectional image. When determining that the estimation of the predetermined region has failed, the image processing apparatus 10 estimates the predetermined region again by using another algorithm. When the estimation has failed, by using the other algorithm, the image processing apparatus 10 can improve estimation accuracy in the estimation of the predetermined region.

Note that, in the first embodiment, the acquisition unit 45 estimates the endocardial contour by using the two-dimensional reference cross-sectional image cut out on the basis of the result of the estimation of the reference cross-section parameters, but the estimation may also be performed using, e.g., a three-dimensional image obtained by providing the reference cross section with a given thickness. Even in the case of using the three-dimensional image, the methods of the learning and estimation are the same as those in a case of using the two-dimensional reference cross-sectional image. Since the acquisition unit 45 estimates the endocardial contour by also considering information on a depth direction, it is possible to further improve the estimation accuracy.

When it is determined in Step S206 that the estimation of the endocardial contour has failed, the acquisition unit 45 switches to another algorithm and performs the estimation of the endocardial contour again, but may also receive a manual correction instruction from the user instead of switching the algorithm. In this case, the image processing apparatus 10 notifies the user of the failed estimation via the display unit 36, and receives the correction instruction from the user via the operation unit 35. The acquisition unit 45 can acquire, as the estimation result, the endocardial contour corrected on the basis of the user instruction. Even when the endocardial contour estimation by the acquisition unit 45 has failed, by correcting the endocardial contour (predetermined region) estimated in Step S205 on the basis of the user instruction, the acquisition unit 45 can set the endocardial contour that more precisely reflects the intention of the user. When the correction instruction is allowed to be received from the user, the acquisition unit 45 needs only to have at least one algorithm that estimates the endocardial contour.

According to the first embodiment described above, the image processing apparatus 10 determines whether or not the estimation of the predetermine region, such as the endocardial contour of the right ventricle, is successful by using information related to the invalid region outside the image capturing range in the reference cross-sectional image. By using the information related to the invalid region, the image processing apparatus 10 can improve the estimation accuracy in the processing of estimating the predetermined region in the reference cross-sectional image.

### First Modification of First Embodiment

A description will be given of a first modification of the first embodiment. The first embodiment shows an example in which the input three-dimensional image serving as the processing target is the three-dimensional ultrasonic image obtained by capturing an image of the right ventricular region of the heart. By contrast, the first modification shows an example in which an image obtained by capturing an image of a region of the heart other than the right ventricle or another organ other than the heart and an image resulting from another modality are used as processing targets, and the predetermined region is estimated.

As an example in which the predetermined region is estimated on an image obtained by photographing a region other than the right ventricular region of the heart by using a modality other than the ultrasonic apparatus, a case where a predetermined structure such as a lung or a large intestine is to be detected from a CT image can be listed. Depending on whether or not each pixel value of the CT image is a predetermined pixel value presenting the invalid region, the image processing apparatus 10 determines the inside or outside of the reconstruction range, and can determine the outside of the reconstruction range to be the invalid region. Alternatively, the image processing apparatus 10 may also define the invalid region by determining an air region to be the invalid region or extracting an extrathoracic region, an adjacent organ region, or the like by using another known segmentation method.

According to the first modification, the image processing apparatus 10 acquires the invalid region and can accurately determine whether or not estimation of the predetermine region is successful even with respect to a modality image other than a three-dimensional ultrasonic image or even when a region other than the right ventricle of the heart is used as the estimation target.

### Second Modification of First Embodiment

A description will be given of a second modification of the first embodiment. The first embodiment shows an example in which, using the two types of algorithms using the CNN and the PCA, the coordinates of each of the points in the right ventricular endocardial contour point group are estimated on the two-dimensional reference cross-sectional image. By contrast, the second modification shows an example in which the estimation is performed using another algorithm other than these two types and an example in which another estimation target (predetermined region) other than the endocardial contour point group is to be estimated.

As an example of the predetermined region other than endocardial contour point group, a segmentation mask image representing a region (predetermined region) of the object can be listed. The acquisition unit 45 can estimate the region of the object by using U-Net described in Olaf Ronneberger et al., U-Net: Convolutional Networks for Biomedical Image Segmentation, Medical Image Computing and Computer-Assisted Intervention-MICCAI 2015, Lecture Notes in Computer Science, vol. 9351, pp. 234-241. Meanwhile, when the predetermined region is to be estimated by using the algorithm based on the PCA described in Toshiyuki Amano et al., An appearance based fast linear pose estimation, MVA 2009 IAPR Conference on Machine Vision Applications, the acquisition unit 45 can replace the estimation target with the segmentation mask image.

As examples of the algorithm other than those using the CNN and the PCA, a deep learning method other than the CNN such as a vision transformer and a machine learning method other than deep learning, such as a support vector machine, can be listed. Meanwhile, as the algorithm that estimates the predetermined region, a method of applying an average shape template of the object, such as template matching, can be listed. Alternatively, the algorithm that estimates the predetermined region may also be a method not based on the learning data, such as that of acquiring a location with a high brightness gradient in an image as a contour.

Thus, the acquisition unit 45 is not limited to a case of estimating a plurality of contour points of the predetermined region, and can estimate the predetermined region as a mask image representing the predetermined region or the like. In this case, when a part of the predetermined region is present in the invalid region, the determination unit 46 can determine that the estimation of the predetermined region has failed.

Alternatively, the acquisition unit 45 may also estimate the coordinates of each of the points in the right ventricular endocardial contour point group on the basis of three or more types of algorithms. In other words, not only the two types of methods using the CNN/PCA, but also the various methods described above can also be combined with each other. When each of the CNN/PCA, which are the methods based on the learning model, has failed, the acquisition unit 45 can also calculate a contour by using a method not based on the learning model, such as that of, e.g., detecting a location with a high brightness gradient in an image and outputting the location as the contour. By having the two or more types of algorithms (estimation methods), the acquisition unit 45 can reduce a risk of a failure in the endocardial contour estimation.

According to the second modification, the image processing apparatus 10 can perform the processing of estimating the predetermined region by using not only the CNN and the PCA, but also various estimation targets and algorithms without limiting the estimation target to the endocardial contour point group.

### Third Modification of First Embodiment

A description will be given of a third modification of the first embodiment. The first embodiment shows an example in which the invalid region is a region that does not vary depending on a state of the object or image capturing timing, such as a region outside the image capturing range of the input three-dimensional image or the outside of the image reconstruction region. By contrast, the third modification shows an example in which, in a case of estimating the predetermined region while acquiring a three-dimensional ultrasonic image varying from time to time, the invalid region varies according to the image capturing timing.

As an example of the invalid region varying according to the image capturing timing, a region of a surgical instrument inserted in a body when, e.g., intraoperative navigation is performed under ultrasonic guidance can be listed. As another example of the varying invalid region, a region other than the periphery of a contour extracted in a previous frame, such as an immediately preceding frame, when a three-dimensional ultrasonic wave performs contour extraction in a plurality of frames of a moving image can be listed. Even when the invalid region varies according to the image capturing timing, the image processing apparatus 10 can acquire the invalid region and accurately determine whether or not the estimation of the predetermine region is successful.

### Second Embodiment

A description will be given of the second embodiment. In the same manner as in the first embodiment, an image processing apparatus 70 according to the second embodiment uses the three-dimensional image as an input image to estimate the reference cross-section parameters representing the position and orientation of the reference cross section for observing the right ventricle as well as the coordinates of each the points in the right ventricular endocardial contour point group on the reference cross-sectional image.

The first embodiment shows an example in which, when it is determined in Step S206 that the endocardial contour estimation has failed, the endocardial contour is estimated again by using another algorithm that estimates the endocardial contour on the basis of the two-dimensional reference cross-sectional image. By contrast, the second embodiment shows an example in which an initial region of the endocardial contour is estimated in advance such that the successful estimation is determined in Step S206 and, when it is determined that the estimation of the endocardial contour based on the two-dimensional reference cross-sectional image has failed, the initial region of the endocardial contour is adopted. Consequently, when it is determined in Step S206 that the endocardial contour estimation has failed, the image processing apparatus 70 does not perform the estimation of the endocardial contour again, and accordingly it is possible to reduce time for the estimation processing and stably estimate the predetermined region.

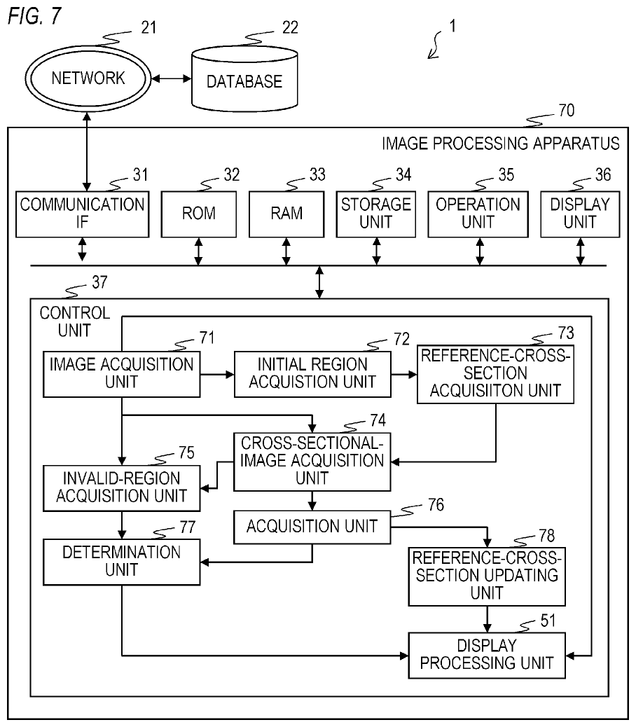

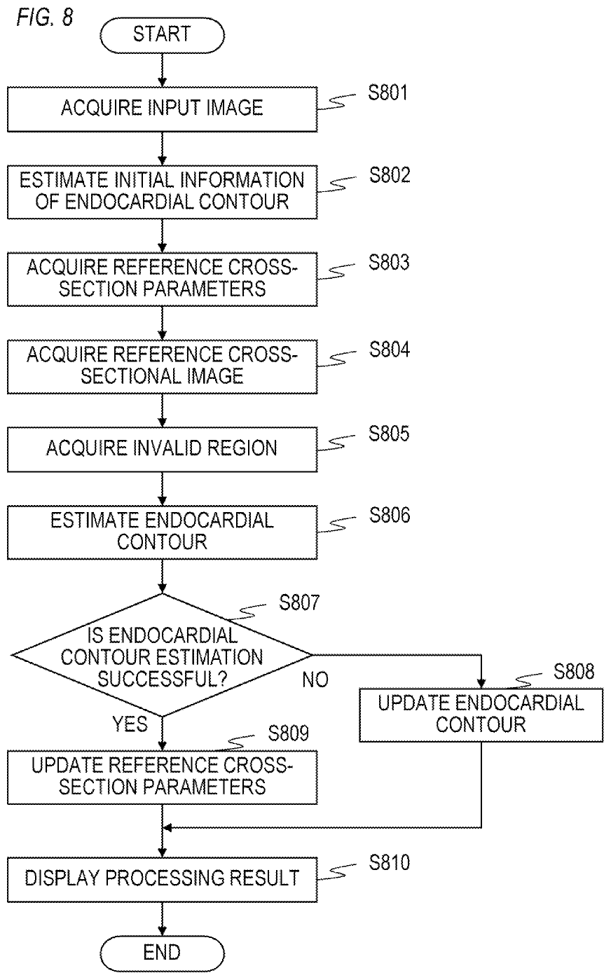

Referring to FIG. 7, a description will be given of a configuration of and processing in the image processing apparatus 70 according to the second embodiment. FIG. 7 is a diagram illustrating an example of the configuration of the image processing system 1 according to the second embodiment. Note that a detailed description of the same configurations and processing as those in the first embodiment is omitted.

The configurations denoted by the same reference signs as those in FIG. 1 have the same functions as those in the first embodiment. In FIG. 7, respective functions of an image acquisition unit 71, a cross-sectional-image acquisition unit 74, an invalid-region acquisition unit 75, an acquisition unit 76, and a reference-cross-section updating unit 78 are the same as the functions of the image acquisition unit 41, the cross-sectional-image acquisition unit 43, the invalid-region acquisition unit 44, the acquisition unit 45, and the reference-cross-section updating unit 47 in FIG. 1. Note that, in the following example, a description will be given of a mode in which the acquisition unit 76 estimates the endocardial contour (predetermined region), but the acquisition unit 76 may also acquire the result of the estimation of the endocardial contour performed by the external device, similarly to the acquisition unit 45 in the first embodiment.

An initial-region acquisition unit 72 uses the input three-dimensional image acquired by the image acquisition unit 71 to estimate the initial region representing the right ventricular endocardial contour. Unlike the acquisition unit 76 that outputs the two-dimensional coordinates of each of the points in the endocardial contour point group on the basis of the two-dimensional reference cross-sectional image, the initial-region acquisition unit 72 uses the three-dimensional image as an input to output three-dimensional coordinates of each of the points in the endocardial contour point group. The three-dimensional coordinates output from the initial-region acquisition unit 72 are used as information representing the initial region of the endocardial contour. Details of processing in which the initial-region acquisition unit 72 outputs (estimates) an initial endocardial contour will specifically be described in a description of Step S802 in FIG. 8. Note that, in the following example, a description will be given of a mode in which the initial-region acquisition unit 72 estimates the initial region of the endocardial contour (predetermined region), but the initial-region acquisition unit 72 may also acquire a result of the estimation of the initial region of the endocardial contour performed by the external device.

The reference-cross-section acquisition unit 73 uses the three-dimensional coordinates of each of the points in the right ventricular endocardial contour point group estimated by the initial-region acquisition unit 72 to acquire the reference cross-section parameters. Details of processing of acquiring the reference cross-section parameters will specifically be described in a description of Step S803 in FIG. 8.

Similarly to the determination unit 46 in the first embodiment, the determination unit 77 uses information on the invalid region acquired by the invalid-region acquisition unit 75 and information on the endocardial contour estimated by the acquisition unit 76 to determine whether or not the estimation of the endocardial contour has failed. When it is determined that the endocardial contour estimation has failed, the determination unit 77 replaces the information on the endocardial contour the estimation of which is determined to be a failure with the initial region of the endocardial contour estimated by the initial-region acquisition unit 72. Details of processing of determining whether or not the endocardial contour estimation is successful will specifically be described in a description of Steps S807 and S808 in FIG. 8.

FIG. 8 is a flow chart illustrating an example of processing in the image processing apparatus 70 according to the second embodiment. Processing in Steps S801, S804 to S807, and S809 in FIG. 8 is the same as the processing in Steps S201, S203 to S206, and S208 in FIG. 2 according to the first embodiment. Note that the two-dimensional reference cross-sectional image acquired in Step S804 in the second embodiment corresponds to the object image. A description will be given below of processing different from that in the first embodiment.

(Step S802: Estimation of Initial Region of Endocardial Contour) In Step S802, the initial-region acquisition unit 72 estimates, in the input three-dimensional image acquired in Step S801, the three-dimensional coordinates of the individual points in the endocardial contour point group in a three-dimensional space as the initial region of the endocardial contour. The initial-region acquisition unit 72 estimates the three-dimensional coordinates of the individual points such that none of the points in the endocardial contour point group is included in the invalid region. In other words, the initial-region acquisition unit 72 estimates the initial region of the predetermined region such that the predetermined region serving as the estimation target does not include the invalid region.

In the second embodiment, the initial-region acquisition unit 72 estimates the initial region of the endocardial contour by using the learning model trained using the CNN. The learning model for estimating the initial region of the endocardial contour is a model built by causing relationships between a three-dimensional ultrasonic image obtained by capturing an image of the right ventricular region and the three-dimensional coordinates of the individual points in the corresponding endocardial contour point group to be learned by using the CNN. The initial-region acquisition unit 72 uses the built learning model to estimate the three-dimensional coordinates of the individual points in the endocardial contour point group in the input three-dimensional image.

When the coordinate value outside the image definition range of the input three-dimensional image is output as a result of the estimation using the learning model based on the CNN, the initial-region acquisition unit 72 controls the coordinate value such that the coordinate value falls within the image definition range. Specifically, in a case where the three-dimensional image input to the learning model using the CNN has 64×64×64 voxels, the initial-region acquisition unit 72 rewrites, when any of the components of the estimated coordinate value is less than 0, the component to 0 and rewrites, when any of the components of the estimated coordinate value is larger than 63, the component to 63.

Note that, in Step S802, the initial region of the endocardial contour is estimated by using the three-dimensional image as the input. However, the initial region of the endocardial contour is not a point group representing a three-dimensional shape of the right ventricle, but the point group representing a two-dimensional contour in a plane (reference cross section) placed in the three-dimensional space.

The initial region of the endocardial contour estimated in Step S802 has a possibility that estimation accuracy is lower than that for the endocardial contour estimated in Step S806, but is controlled such that the estimation is determined to be successful in the determination in Step S807. Referring to FIGS. 4A and 4B, a specific example in which control is performed such that the estimation of the initial region of the endocardial contour is determined to be successful will be described.

In FIGS. 4A and 4B, the invalid region is the three-dimensional region outside the definition range of the input three-dimensional image (outside the image capturing range). When the endocardial contour is estimated on the basis of the two-dimensional reference cross-sectional image as in Step S205 in the first embodiment, in the two-dimensional reference cross-sectional image region illustrated in FIG. 4B, the invalid regions (the regions 411 and 412) are present. As a result, a result of the estimation by the acquisition unit 76 may possibly be located in the invalid region.

Meanwhile, a range of the endocardial contour as the initial region estimated in Step S802 is controlled to be located within the definition range of the input three-dimensional image, i.e., within the valid region. Note that, in the same manner as in Step S202 in the first embodiment, the initial-region acquisition unit 72 may also reduce the definition of the input three-dimensional image and perform the estimation processing in Step S802. In a case of using the three-dimensional image with a reduced resolution (low resolution), the accuracy of the estimation of the initial region of the endocardial contour may be lower than in the case where a high-resolution two-dimensional reference cross-sectional image is used in Step S205 in the first embodiment. However, it is possible to perform control such that the initial region of the endocardial contour is located within the valid region.

(Step S803: Acquisition of Reference Cross-Section Parameters) In Step S803, the reference-cross-section acquisition unit 73 acquires the reference cross-section parameters from the initial region of the endocardial contour estimated in Step S802. The initial region of the endocardial contour is represented by, e.g., the three-dimensional coordinates of the individual points in the endocardial contour point group estimated by the initial-region acquisition unit 72. Unlike in Step S202 in the first embodiment, unknown parameters are not estimated in processing in Step S803, and the reference-cross-section acquisition unit 73 can uniquely calculate the reference cross-section parameters from the three-dimensional coordinates of the individual points in the endocardial contour point group.

A specific description will be given of the processing in Step S803. First, the reference-cross-section acquisition unit 73 uses fitting of a least square cross section, which is a known method, to determine a least square cross section which is a cross section that minimizes differences between distances to the individual points in the endocardial contour point group of the initial region and calculate a normal vector (nx, ny, nz) of the least square cross section. Then, the reference-cross-section acquisition unit 73 projects the individual points in the endocardial contour point group of the initial region on the least square cross section. The reference-cross-section acquisition unit 73 treats the endocardial contour point group projected on the least square cross section as an endocardial contour point group as a new initial region. The reference-cross-section acquisition unit 73 uses, as the horizontal axis vector (sx, sy, sz), a vector obtained by connecting the left and right valve annuli by using a midpoint between the left and right valve annuli in the projected endocardial contour point group as the center position (cx, cy, cz). The vertical axis vector (lx, ly, lz) is calculated by determining an inner product of the horizontal axis vector and the normal vector.

By processing as described above, the reference-cross-section acquisition unit 73 can calculate the right ventricular endocardial contour illustrated by way of example in FIG. 3B and the reference cross-section parameters for the right ventricular reference cross section. In other words, the center position of the reference cross section matches the middle between the left and right valve annuli, the axis connecting the left and right valve annuli matches the horizontal axis vector, and all the points in the endocardial contour are placed on the cross section.

(Step S808: Updating of Endocardial Contour) When it is determined in Step S807 that the estimation of the endocardial contour has failed, the determination unit 77 updates the endocardial contour in Step S808. The determination unit 77 adopts the initial region of the endocardial contour estimated in Step S802 as a result of final estimation of the endocardial contour output from the image processing apparatus 70.

(Step S810: Display of Processing Result) In Step S810, the display processing unit 51 displays, on the image display region of the display unit 36, information on a result of the processing in the image processing apparatus 70 in a display mode easily visually recognizable by the user. Examples of the information on the processing result include the two-dimensional reference cross-sectional image based on the reference cross-section parameters acquired in Step S803 and the right ventricular endocardial contour estimated in Step S802 or Step S806.

Note that, when it is intended to perform analysis and measurement based on the reference cross section and the object shape such as the estimated right ventricular endocardial contour, in the same manner as in Step S209 in FIG. 2, the display processing unit 51 need not perform the display processing in Step S810. In this case, the right ventricular endocardial contour, the reference cross-section parameters, and the results of determining whether or not the estimation is successful obtained in Steps S802, S803, S806, S807, and S809 may also be stored in the RAM 33 or the storage unit 34 or output to the external device.

According to the second embodiment described above, the image processing apparatus 70 estimates the initial region of the endocardial contour such that the successful estimation is determined by the determination unit 77. As a result, even when the estimation of the endocardial contour has failed with each of the algorithms, the image processing apparatus 70 can output the initial region of the endocardial contour as the estimation result.

### Third Embodiment

A description will be given of the third embodiment. In the same manner as in the first embodiment and the second embodiment, an image processing apparatus 90 according to the third embodiment uses the three-dimensional image as the input image to estimate the reference cross-section parameters and the coordinates of the individual points in the right ventricular endocardial contour point group.

In the first embodiment and the second embodiment, the processing of estimating the endocardial contour in the two-dimensional reference cross-sectional image is performed. Meanwhile, in the third embodiment, the image processing apparatus 90 estimates the endocardial contour on the basis of only the input three-dimensional image without using the two-dimensional reference cross-sectional image, acquires information on the invalid region, and determines whether or not the estimation of the endocardial contour is successful. In other words, in the third embodiment, the image processing apparatus 90 does not estimate the endocardial contour in the two-dimensional reference cross-sectional image, but estimates the endocardial contour in a three-dimensional space. The input three-dimensional image in the third embodiment corresponds to the object image.

Since the image processing apparatus 90 estimates the endocardial contour in consideration of the entire input three-dimensional image, compared to a case where the endocardial contour is estimated in the two-dimensional reference cross-sectional image as in the first embodiment and the second embodiment, it is possible to reduce a risk of falling into an inappropriate local optimum solution.

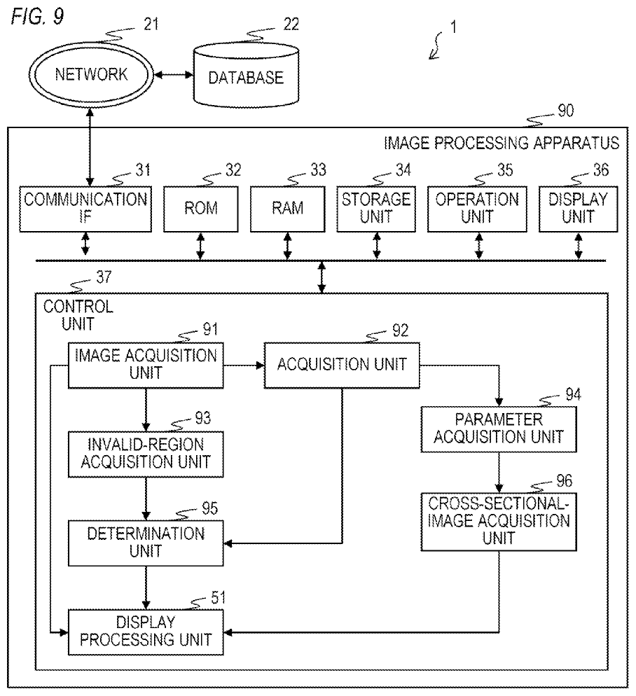

Referring to FIG. 9, a description will be given of a configuration of and processing in the image processing apparatus 90 according to the third embodiment. FIG. 9 is a diagram illustrating an example of the configuration of the image processing system 1 according to the third embodiment. Note that a detailed description of the same configurations and processing as those in the first embodiment and the second embodiment is omitted.

The configurations denoted by the same reference signs as those in FIG. 1 have the same functions as those in the first embodiment. In FIG. 9, respective functions of an image acquisition unit 91, an acquisition unit 92, and a reference-cross-section acquisition unit 94 are the same as the functions of the image acquisition unit 71, the acquisition unit 76, and the reference-cross-section acquisition unit 73 in FIG. 7. Note that, in the following example, a description will be given of a mode in which the acquisition unit 92 estimates the endocardial contour (predetermined region), but the acquisition unit 92 may also acquire the result of the estimation of the endocardial contour performed by the external device, similarly to the acquisition unit 45 in the first embodiment.

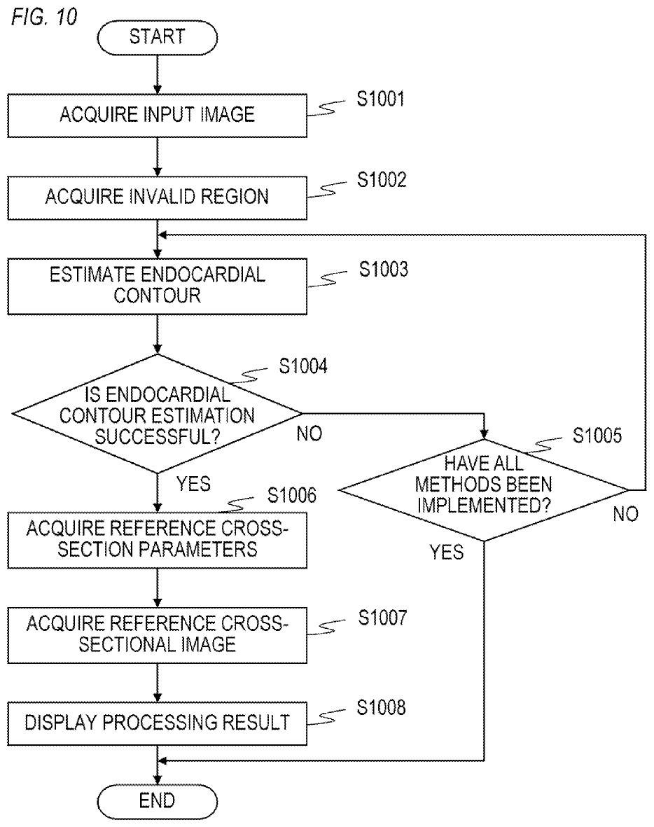

Similarly to the invalid-region acquisition unit 44 in the first embodiment, an invalid-region acquisition unit 93 acquires, from the input three-dimensional image, the invalid region where the endocardial contour should not be located. However, unlike in the first embodiment and the second embodiment, the invalid-region acquisition unit 93 does not perform the processing of coordinate transformation of the invalid region to the space of the two-dimensional reference cross-sectional image. Details of processing in which the invalid-region acquisition unit 93 acquires the invalid region will specifically be described in a description of Step S1002 in FIG. 10.

Similarly to the determination unit 46 in the first embodiment, a determination unit 95 determines whether or not the endocardial contour estimation is successful on the basis of whether or not the estimated endocardial contour is located within the invalid region. However, unlike in the first embodiment and the second embodiment, the determination unit 95 performs the determination not in the definition range of the two-dimensional reference cross-sectional image, but in the three-dimensional space in which the input three-dimensional image is defined. Details of processing of determining whether or not the endocardial contour estimation is successful will specifically be described in a description of Step S1004 in FIG. 10.

Similarly to the cross-sectional-image acquisition unit 74 in the second embodiment, a cross-sectional-image acquisition unit 96 acquires the two-dimensional reference cross-sectional image on the basis of the acquired reference cross-section parameters. However, in the third embodiment, the endocardial contour estimation based on the two-dimensional reference cross-sectional image is not performed, and accordingly the two-dimensional reference cross-sectional image acquired by the cross-sectional-image acquisition unit 96 is used for display. Details of processing of acquiring the reference cross-sectional image will specifically be described in a description of Step S1007 in FIG. 10.

A flow chart in FIG. 10 is a flow chart illustrating an example of the processing in the image processing apparatus 90 according to the third embodiment. The processing in each of Steps S1001 and S1005 in FIG. 10 is the same as the processing in each of Steps S201 and S207 in the flow chart in FIG. 2 according to the first embodiment. Additionally, the processing in each of Steps S1006 and S1007 is the same as the processing in each of Steps S803 and S804 in the flow chart in FIG. 8 according to the second embodiment.

(Step S1002: Acquisition of Invalid Region) In Step S1002, the invalid-region acquisition unit 93 uses the input three-dimensional image acquired in Step S1001 to acquire the invalid region where the endocardial contour should not be located. In the third embodiment, the invalid-region acquisition unit 93 uses, as the invalid region, a region outside the image reconstruction region (region 602) in the three-dimensional ultrasonic image illustrated in FIG. 6A. The invalid-region acquisition unit 93 prepares an invalid region image having the same number of voxels (e.g., 256×256×256 voxels) as that of the voxels of the input three-dimensional image, and stores the pixel value that identifies the invalid region outside the image reconstruction region.

(Step S1003: Estimation of Endocardial Contour) In Step S1003, the acquisition unit 92 estimates the three-dimensional coordinates of the individual points in the right ventricular endocardial contour point group on the basis of the input three-dimensional image acquired in Step S1001. Similarly to Step S802 in FIG. 8 according to the second embodiment, processing in Step S1003 is processing of estimating the three-dimensional coordinates of the individual points in the right ventricular endocardial contour point group on the basis of the input three-dimensional image.

In Step S1004, when “failed estimation” is determined, in order to perform the endocardial contour estimation processing again, the acquisition unit 92 has at least two estimation algorithms. In the third embodiment, the acquisition unit 92 includes two types of algorithms, which are an algorithm based on the CNN and an algorithm based on the PCA. The algorithms included in the acquisition unit 92 are the same as the algorithms included in the acquisition unit 45 in the first embodiment except for the difference in whether the input image to the learning model and the endocardial contour definition space are two-dimensional or three-dimensional.

Note that, in order to suppress the effect of reduced estimation accuracy resulting from a reduced resolution of the input three-dimensional image, the acquisition unit 92 may also use a coarse-to-fine search approach. For example, the acquisition unit 92 estimates, in the three-dimensional image with the reduced resolution, a center (midpoint between a leading end of the right ventricle and a middle between the left and right valve annuli) by using the model based on the CNN or the like at the first stage. Then, the acquisition unit 92 may increase the resolution to the same resolution as that of the input three-dimensional image and subsequently estimate the endocardial contour on the basis of a brightness profile around an approximate position. Such a coarse-to-fine search allows the acquisition unit 92 to increase the estimation accuracy without increasing processing time.

(Step S1004: Determination of Success or Failure of Endocardial Contour Estimation) In Step S1004, the determination unit 95 determines whether or not the endocardial contour estimation is successful on the basis of the invalid region acquired in Step S1002 and the endocardial contour estimated in Step S1003.

In the same manner as in the first embodiment and the second embodiment, whether or not the endocardial contour estimation is successful is determined on the basis of whether or not at least one of the points in the endocardial contour point group is present in the invalid region. However, unlike in the first embodiment and the second embodiment, the determination unit 95 determines whether or not the endocardial contour estimation is successful on the basis of not the invalid region in the two-dimensional reference cross-sectional image, but the invalid region in the three-dimensional space in which the input three-dimensional image is defined. When it is determined that the endocardial contour estimation is successful (YES in Step S1004), the processing advances to Step S1006. When it is determined that the endocardial contour estimation has failed (NO in Step S1004), the processing advances to Step S1005.

(Step S1008: Display of Processing Result) In Step S1008, the display processing unit 51 displays, on the image display region of the display unit 36, information on a result of processing in the image processing apparatus 90 illustrated in FIG. 9 in a display mode easily visually recognizable by the user. Examples of the information on the processing result displayed on the display unit 36 in Step S1008 include the right ventricular endocardial contour, the two-dimensional reference cross-sectional image based on the reference cross-section parameters, and a result of determining whether or not the endocardial contour estimation is successful.

Note that, when it is intended to perform analysis or measurement based on the reference cross section and the object shape such as the estimated right ventricular endocardial contour, the display processing unit 51 need not perform the display processing in Step S1008. In this case, the right ventricular endocardial contour, the result of determining whether or not the estimation is successful, and the reference cross-section parameters which are obtained in Steps S1003, S1004, and S1006 may also be stored in the RAM 33, the storage unit 34, or the like or may also be output to the external device instead of being displayed on the display unit 36.

According to the third embodiment described above, the image processing apparatus 90 estimates the endocardial contour on the basis of the input three-dimensional image without using the two-dimensional reference cross-sectional image, acquires the invalid region, and determines whether or not the endocardial contour estimation is successful. Since the image processing apparatus 90 estimates information on the endocardial contour in consideration of the entire input three-dimensional image, compared to a case where the endocardial contour is estimated in the two-dimensional reference cross-sectional image as in the first embodiment and the second embodiment, it is possible to reduce a risk of falling into an inappropriate local optimum solution.

Note that, in the third embodiment, when it is determined in Step S1004 that the endocardial contour estimation has failed and there is an algorithm that has not been executed (NO in Step S1005), the processing returns to Step S1003. Then, the acquisition unit 92 switches to another algorithm and estimates the endocardial contour again, but may also notify the user of the failed endocardial contour estimation. Alternatively, the acquisition unit 92 may also eliminate a state where the endocardial contour point group is included in the invalid region without involving estimation. For example, the acquisition unit 92 can use the points remaining after exclusion of the point included in the invalid region as the endocardial contour point group. By eliminating the state where the endocardial contour point group is included in the invalid region, the acquisition unit 92 can reduce extra processing time due to re-estimation and output a processing result.

The third embodiment is also applicable to a case where the two-dimensional image is used as the input image. For example, the image processing apparatus 90 may also use an endoscopic image as the input image and estimate information on the predetermined region (object shape). The image capturing range in which the object is actually depicted in the endoscopic image is a circular region, and does not match the two-dimensional image region which is square or rectangular. By defining a region outside the circular region (image capturing range) as the invalid region, the image processing apparatus 90 can accurately determine whether or not the estimation of the predetermined region is successful when the predetermined region is to be detected from the endoscopic image.

According to the technology in the present disclosure, it is possible to improve estimation accuracy in processing of estimating a predetermined region in an image.

### OTHER EMBODIMENTS

The technology in the present disclosure can be embodied as, e.g., a system, an apparatus, a method, a program, a recording medium (storage medium), or the like. Specifically, the technology in the present disclosure may be applied to a system configured to include a plurality of devices (such as, e.g., a host computer, an interface device, an image capturing device, and a web application), or may also be applied to an apparatus including one device.

Needless to say, the object of the present invention is attained by following a procedure as shown below. In other words, a recording medium (or a storage medium) recording thereon a software program code (a computer program) that can implement the function of each of the above-mentioned embodiments is supplied to the system or apparatus. Needless to say, such a storage medium is a computer readable storage medium. A computer (or a CPU, MPU, or the like) of the system or apparatus reads out and executes the program code stored on the storage medium. In this case, the program code read out of the recording medium implements the function of each of the above-mentioned embodiments, and the recording medium recording thereon the program code constitutes the present invention.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-063242, filed on Apr. 10, 2023, which is hereby incorporated by reference herein in its entirety.

What is claimed is:

1. An image processing apparatus comprising:
a memory storing a program; and
one or more processors which, by executing the program, function as:
an image acquisition unit configured to acquire an object image obtained by capturing an image of an object;
an invalid-region acquisition unit configured to acquire information related to an invalid region, which is a region that is outside an image capturing range or where the object is not present, in the object image;
an acquisition unit configured to acquire a result of estimating a predetermined region based on the object image; and
a determination unit configured to determine, by using the information related to the invalid region, whether or not an estimation of the predetermined region is successful.

2. The image processing apparatus according to claim 1,
wherein the acquisition unit acquires a plurality of contour points of the predetermined region, and
wherein the determination unit determines that the estimation of the predetermined region has failed in a case where at least one of the plurality of contour points is present in the invalid region.

3. The image processing apparatus according to claim 1,
wherein the determination unit determines that the estimation of the predetermined region has failed in a case where a part of the predetermined region is present in the invalid region.

4. The image processing apparatus according to claim 1,
wherein the acquisition unit can acquire results of the estimation of the predetermined region using two or more types of estimation methods and acquires, in a case where determination is made by the determination unit that the estimation of the predetermined region by using a first estimation method has failed, the result of the estimation of the predetermined region by using a second estimation method different from the first estimation method.

5. The image processing apparatus according to claim 1,
wherein the acquisition unit acquires a result of the estimation of the predetermined region estimated by using a learning model trained to learn a relationship between the object image and the predetermined region.

6. The image processing apparatus according to claim 1,
wherein the object image is a three-dimensional image, and
wherein the invalid region is a three-dimensional region.

7. The image processing apparatus according to claim 1,
wherein the image acquisition unit acquires the object image by cutting, out of a captured image obtained by capturing the image of the object, a region where the object is depicted, and
wherein the invalid-region acquisition unit acquires the information related to the invalid region based on the captured image.

8. The image processing apparatus according to claim 7,
wherein the captured image is any of an ultrasonic image obtained by an ultrasonic diagnostic apparatus, an X-ray CT image obtained by an X-ray CT (Computed Tomographic) apparatus, and an MRI image obtained by an MRI (Magnetic Resonance Imaging) apparatus.

9. The image processing apparatus according to claim 7,
wherein the captured image is a three-dimensional image, and the object image is a two-dimensional cross-sectional image cut out of the captured image.

10. The image processing apparatus according to claim 9,
wherein the image acquisition unit acquires the two-dimensional cross-sectional image by using a learning model trained by inputting thereto the three-dimensional image so as to output parameters specifying a position and an orientation of the two-dimensional cross-sectional image in the three-dimensional image.

11. The image processing apparatus according to claim 9,
wherein the image acquisition unit acquires the two-dimensional cross-sectional image by using an image obtained by reducing a resolution of the three-dimensional image.

12. The image processing apparatus according to claim 7,
wherein the one or more processors further function as:
an initial-region acquisition unit configured to acquire a result of estimating, based on the captured image, an initial region of the predetermined region in the captured image, and
wherein, in a case where determination is made by the determination unit that the estimation of the predetermined region has failed, the acquisition unit acquires the result of the estimation of the initial region acquired by the initial-region acquisition unit as the result of the estimation of the predetermined region.

13. The image processing apparatus according to claim 12,
wherein the initial-region acquisition unit acquires a result of the estimation of the initial region estimated such that the initial region does not include the invalid region.

14. The image processing apparatus according to claim 1, further comprising:
a display that displays the result of the estimation of the predetermined region and the result of the determination by the determination unit.

15. The image processing apparatus according to claim 1,
wherein, in a case where determination is made by the determination unit that the estimation of the predetermined region is a failure, the acquisition unit acquires, as the result of the estimation, the predetermined region corrected based on an instruction from a user.

16. An image processing method comprising:
acquiring an object image obtained by capturing an image of an object;
acquiring information related to an invalid region, which is a region that is outside an image capturing range or where the object is not present, in the object image;
acquiring a result of estimating a predetermined region based on the object image; and
determining, by using the information related to the invalid region, whether or not an estimation of the predetermined region is successful.

17. A non-transitory computer-readable medium that stores a program for causing a computer to execute an image processing method comprising:
acquiring an object image obtained by capturing an image of an object;
acquiring information related to an invalid region, which is a region that is outside an image capturing range or where the object is not present, in the object image;
acquiring a result of estimating a predetermined region based on the object image; and
determining, by using the information related to the invalid region, whether or not an estimation of the predetermined region is successful.
